(19) United States
(12) Patent Application Publication
(10) Pub. No.: US 2017/0308845 A1
(43) Pub. Date: Oct. 26, 2017

(54) ASSET TAG AND METHOD AND DEVICE FOR ASSET TRACKING

(71) Applicant: Inventor-e Limited, Solihull (GB)

(72) Inventor: Dean Charles HENRY, Solihull (GB)

(21) Appl. No.: 15/139,058

(22) Filed: Apr. 26, 2016

(51) Int. Cl. G06Q 10/08; G06K 7/10; H04B 5/00

(52) U.S. Cl. CPC G06Q 10/087; H04B 5/0062; G06K 7/10128; G06K 7/10138

(57) ABSTRACT

An asset tag adapted to be mounted to an asset, the asset tag comprising a first component encoded with a first ID unique to the asset tag, the first component having a first wireless interface and being adapted to transmit first broadcast signals via said first wireless interface over a first range, the first broadcast signals including the first ID. The asset tag comprises a second component encoded with a second ID unique to the asset tag, the second component having a second wireless interface and being adapted to transmit second broadcast signals via said second wireless interface over a second range, the second broadcast signals including the second ID. The first range and the second range are different. The first ID and the second ID are identical.

### BACKGROUND

### Field

The present invention relates to electronic stock or asset monitoring techniques, and more particularly to an asset tag and method and device for asset tracking.

### Description of the Related Art

This invention concerns systems and methods for providing monitoring of quantities of stock or assets in an accurate and preferably secure manner, in storage environments where hand-portable stock items can be stored and accessed by a user or, more typically, a multitude of different users or employees. Such storage environments are typically found at manufacturing, construction, aerospace, healthcare and other sites. The assets may include tools, consumable materials, and single-use and reusable items. As used herein, “item”, “product” and “asset” may be used interchangeably; and assets may be referred to generally as “indirect materials” or “inventory”.

In prior art systems the amount of stock retrieved or removed from storage has been determined using tags. For example, WO2006/000016A1 discloses an apparatus for detecting removal of items from a compartment. The apparatus comprises a reader for reading Radio Frequency Identification (RFID) tags attached to items in the compartment and a processor, coupled to the reader, for identifying items removed from the compartment. US2016/071052A1 discloses a stock monitoring system, for monitoring items of stock in one or more storerooms for stock items using, inter alia, a reader and/or wireless transmitter being adapted for short-range communication. The reader, wireless transmitter and/or the first wireless transceiver may comprise a near field communication (NFC) device, and the tag may comprise a NFC RFID tag.

US2015/222740A1 discloses a wireless alerting system for personal area asset supervision; the system includes an observing device, using a host apparatus such as Bluetooth®, capable of monitoring at least one identifier device located within a selected proximity which encompasses an area in a selected radius of distance. The identifier device is a generic tag or customized to some extent in the system for attachment to any item.

US2016/105762A1 discloses an asset monitoring and tracking system with a distributed Bluetooth® low energy (BTLE) sensor system of heterogeneous sensors over wireless networks. One or more Bluetooth® assets having a Bluetooth radio are associated with a specific set of business rules by enterprise users. Scan event data is received from at least one of a plurality of Bluetooth® sensors having Bluetooth® radios, wirelessly distributed around a communication network. The scan event data results from a scan event wherein the Bluetooth® asset was within range of the at least one Bluetooth® sensor. A BTLE device comprises a Bluetooth tag, a Bluetooth device app, and a Bluetooth radio.

Thus, asset tagging and/or tracking techniques are known in which either NFC (RFID) tags or Bluetooth tags are used. However, a problem with such systems is that some organisations have thousands of assets across their sites, and the process of setting up the Bluetooth tags by a user is onerous and time consuming.

A further problem is that there is a requirement to read the Bluetooth signal into software or pair the tag with a mobile device using a button on the Bluetooth tag, complicating the setup of links. Also, the number of Bluetooth tags that can be paired with one mobile device is limited (traditionally, only up to six).

A further problem is that asset tags (especially Bluetooth) can be difficult to fabricate so as to be made waterproof. Also, with Bluetooth tags battery life can limit usage, due to depletion in use: asset management can be prevented when the battery is depleted in the Bluetooth tag. It can also be difficult to obtain the ID of a tag that requires battery changeout.

A further problem with Bluetooth tags is that unauthorised actors can connect to the Bluetooth component so that it is possible for the tag to be hacked.

A further problem with traditional tags is that booking of a particular asset/tool to a job for an operative using vehicles and/or moving between and sites.

A further problem is that suitable techniques do not exist for locating/tracking assets at a site using a portable device.

A further problem is that suitable techniques do not exist allowing automated reading of assets within a store, i.e. ‘always on’ technology.

Additionally, the (logging/tracking of the) “on the go” transfer of a tethered asset from one user (e.g. engineer) to another is not facilitated with conventional systems.

A further problem is that suitable techniques do not exist for identifying and/or locating tools that have been damaged and are no longer fit for use or require repair.

Also, conventional systems do not provide optimal techniques for vibration white finger monitoring and recording the physical state/condition of an asset.

### SUMMARY

According to one embodiment of this disclosure, there is provided an asset tag adapted to be mounted to an asset. The asset tag comprises a first component encoded with a first ID unique to the asset tag, the first component having a first wireless interface and being adapted to transmit first broadcast signals via said first wireless interface over a first range, the first broadcast signals including the first ID. The asset tag further comprises a second component encoded with a second ID unique to the asset tag, the second component having a second wireless interface and being adapted to transmit second broadcast signals via said second wireless interface over a second range, the second broadcast signals including the second ID. The first range and the second range are different. The first ID and the second ID are identical.

The first wireless interface may be a transmit-only wireless interface.

In one embodiment, the first wireless interface is adapted to transmit the first broadcast signals with a first periodicity T1.

The first wireless interface may be a battery-powered wireless interface.

Preferably, the first wireless interface is a Bluetooth interface.

The second wireless interface may be a wireless transceiver.

In one embodiment, the second wireless interface is adapted to transmit the second broadcast signals with a second periodicity T2.

In one embodiment, the second wireless interface may be a battery-powered wireless interface.

In another embodiment, the second wireless interface is a passive wireless interface. The second wireless interface may be adapted to transmit, upon interrogation by a corresponding reader device, a second broadcast signal.

Preferably, the second wireless interface is a NFC interface.

According to another embodiment of this disclosure, there is provided a method of tethering an asset to a portable asset tracking device, the portable asset tracking device having a unique device ID and being coupled via a third wireless interface to a remote asset tracking server. The method comprises providing at least one asset, the or each asset having mounted thereto any asset tag as described herein. The method further comprises, upon the portable asset tracking device being brought into proximity or tapped onto the asset tag of the or each asset: receiving the respective second broadcast signal; decoding the second broadcast signal to obtain the second ID; and retrieving the device ID. The method further comprises updating an asset tracking database on the portable asset tracking device and/or at the remote asset tracking server to include an association between the device ID and the second ID.

According to another embodiment of this disclosure, there is provided a method of transferring an assert that is tethered to a first portable asset tracking device to a second portable asset tracking device, each portable asset tracking device having a unique device ID and being coupled via a third wireless interface to a remote asset tracking server. The method comprises providing an asset, the asset having mounted thereto an asset tag as described herein. The method further comprises: upon the first portable asset tracking device being brought into proximity or tapped onto the asset tag of the asset, receiving the first broadcast signal; decoding the first broadcast signal to obtain the first ID; using the first ID, and retrieving the asset data corresponding to the tag from an asset database. The method further comprises receiving a first user input at the first portable asset tracking device indicating that the asset has been transferred. The method further comprises: upon the second portable asset tracking device being brought into proximity or tapped onto the asset tag of the asset, receiving the second broadcast signal; and decoding the second broadcast signal to obtain the second ID. The method further comprises updating an asset tracking database on the second portable asset tracking device and/or at the remote asset tracking server to include an association between the device ID of the second portable asset tracking device and the second ID.

The method may comprise, after said step of retrieving the asset data corresponding to the tag from an asset database, displaying the asset data in a user interface of the first portable asset tracking device.

According to another embodiment of this disclosure, there is provided a method of tracking the location of an asset at a site using a wireless portable device, the wireless portable device including a receiver and an orientation-sensing device for providing an orientation signal, the asset having mounted thereto a tag as described herein. The method comprises receiving a first user input at the wireless portable device, the first user input selecting the asset. The method further comprises receiving via the receiver one or more of said first broadcast signals. The method further comprises determining the signal strength of said one or more of said first broadcast signals. The method further comprises deriving a measure based on the signal strength. The method further comprises determining the current orientation of the wireless portable device based on said orientation signal. The method further comprises graphically displaying (i) an orientation element indicating the current orientation and (ii) the measure.

The orientation element may comprise a compass.

The measure may comprise a bar of length corresponding to the determined signal strength.

According to another embodiment of this disclosure, there is provided a method of measuring usage of an asset, the asset comprising a manually-operable tool having mounted thereto a tag as described herein, the tag including an accelerometer for generating, in use, accelerometer data indicative of whether the asset is active or inactive, the method being carried out on a wireless portable device. The method comprises receiving one or more first broadcast signals, the first broadcast signals including the first ID of the tag and the accelerometer data. The method further comprises determining, from the accelerometer data, whether an asset usage status is active/inactive. The method further comprises storing or causing to be stored the asset usage status and associated first ID and a timestamp of the current time in a usage database. The method further comprises, in response to a first user input at the wireless portable device, the first user input selecting the asset. The method further comprises retrieving aggregated temporal usage data for the selected asset, the aggregated temporal usage data being based at least in part on the asset usage status. The method further comprises graphically displaying the aggregated temporal usage data.

The graphically displayed aggregated temporal usage data may comprise, for a given operative, one or more tag IDs and, associated with each tag ID, at least an aggregated usage time for each day of usage.

In embodiments, storing or causing to be stored the asset usage status and associated first ID and a timestamp of the current time in a usage database comprises (i) storing the asset usage status in a local database on the wireless portable device and (ii) causing the asset usage status to be stored comprises causing the asset usage status to be stored on a usage database on a remote assert server.

In embodiments, retrieving the aggregated temporal usage data for the selected asset comprises retrieving the aggregated temporal usage data from (i) a local database on the wireless portable device or (ii) a usage database on a remote asset server.

According to another embodiment of this disclosure, there is provided a wireless portable device or server, the wireless portable device or server incorporating a processor, memory and at least one communications interface, the processor being configured to carry out any of the above the methods set out in any of the appended claims or as described herein.

According to another embodiment of this disclosure there is provided a recordable, rewritable or recorded medium having recorded or stored thereon machine readable data defining or transformable into instructions for execution by processing circuitry and corresponding to at least the steps of the methods set out in any of the appended claims.

According to another embodiment of this disclosure there is provided a server computer incorporating a communications device and a memory device and being adapted for transmission on demand or otherwise of data defining or transformable into instructions for execution by processing circuitry and corresponding to at least the steps of any of the appended claims.

Implementation of the processing on the PDA (which is e.g. phone, tablet or other portable computing device) with NFC-RFID (Near Field Communication Radio Frequency Identification capability) and Bluetooth may be by means of an application that is downloaded to the PDA. The PDA may be linked in real time through 3G/4G/5G to cloud-based central computer (CC) software. The CC software may be an enterprise-wide asset or indirect materials management platform.

The (composite) asset tag disclosed herein is a unique asset and inventory management electronic tag combining both NFC (Near Field Communication) technology and short range wireless communication technology (e.g. Bluetooth) and in some circumstances RFID technology. This can be achieved using a combined Bluetooth NFC chip or simply combining a Bluetooth tag with an NFC tag but encoding the NFC tag with the Bluetooth identifier and adding an RFID tag.

The (composite) asset tag disclosed herein allows the following advantages:

1. The NFC component of the composite tag can be encoded with the Bluetooth (Short range wireless communication technology identifier (Media Access Control) MAC address. The benefit is that it significantly speeds up the process of setting up the Bluetooth tags by a user making it more convenient and user friendly process particularly for multiple tag set up for multiple assets with a mobile NFC capable device.
2. The NFC component of the composite tag allows the control of assets to a home store or van within a cloud based software using an NFC capable mobile device without the requirement to read the Bluetooth signal into the software or pair the tag with a mobile using a button on the Bluetooth tag (the traditional method).
3. Traditionally, only up to six Bluetooth tags can be paired with one mobile device. The NFC component of the composite tag removes the requirement for ‘pairing’ (two-way communication requirement) as we are only listening for specific Bluetooth signals and therefore allows “virtual” tethering (within asset tracking software) of substantially more composite tags, and therefore assets, to a mobile device.
4. The additional benefit of NFC as the identifier and (and avoiding using a button to pair the tag to the smart mobile device) is that the composite tag can be made to be waterproof and more cost effective. The conventional addition of a button makes waterproofing extremely difficult.
5. Another benefit of NFC component of the composite tag is that it increases the life of the battery, as the composite tag can work as a beacon-only, utilising one-way communication from the tag to the mobile device. I.e. the composite tag doesn't need to listen to any signals going to it and doesn't need to be ‘paired’. This one-way communication increases the life in service of the composite tag between battery changes. With a button on a Bluetooth tag, it has to communicate in both directions with a mobile smart device.
6. The composite tag is also much more secure: anyone can listen to the composite tag as it only broadcasts. Effectively the composite tag can't be hacked and settings changed, as no-one can connect to the Bluetooth component of the composite tag.
7. The NFC component of the composite tag allows the scanning of the composite tag to record data (about the asset e.g. Part number, serial number, description, calibration dates, inspection checks, training records of the inspector being up to date, information PDF's, how to use videos, the ability to photograph parts or all of the asset, to highlight issues on inspection etc.) to a cloud based software.
8. The NFC component of the composite tag allows the booking of a particular asset/tool to a job. E.g. an engineer takes a drill and an angle grinder from several assets on their vehicle. These can be booked to the job, so it records them going on to a particular site. When the engineer gets back to the vehicle he can scan them back onto the vehicle or home store. This gives a record and audit trail of the time specific tools are allocated to a job.
9. The Bluetooth or short range wireless communication component of the composite tag allows the composite tag to be tracked using signal strength by the Bluetooth network on a mobile device with Bluetooth capability.
10. The cloud based (asset monitoring/tracking) software allows the Bluetooth network of the whole community to track specific assets/tools, i.e. with anyone with their Bluetooth and PDA application enabled.
11. The Bluetooth and RFID element of the composite tag allows reader tiles—which can fit onto walls and into suspended ceilings using power over Ethernet and that have readers for both the Bluetooth and RFID element—to read both elements of the composite tags. The tiles can detect the proximity of passive RFID tagged assets (up to 6 metres radius) and Bluetooth tagged assets up to 50 metres. This allows automated reading of assets within a stores, i.e. ‘always on’ technology and when they are booked to an operative via a PDA application using the NFC component they are automatically allocated to the operative and their vehicle (using Vehicle registration and operatives clock card using inventory management software).
12. The composite tag placed on an asset can be NFC scanned to tether the asset to a mobile device using the Bluetooth (short range wireless communication technology.)
13. The composite tags of a specific asset can be scanned by another engineer to show an asset/tool transfer from one engineer to another in the cloud based (asset monitoring/tracking) software. This also automatically tethers the Bluetooth component of the composite tag to the new engineer's smart device; this allows the lending of tools between operatives to be a seamless process.
14. The Bluetooth and NFC components together ensure two ways of reading an asset into the cloud based (asset monitoring/tracking) software—a passive method by scanning by a user and an active Bluetooth method where the smart mobile device automatically reads the Bluetooth signal. This also means asset management can still be carried out even when the battery is depleted in the Bluetooth tag and requires changing. As NFC reader uses the battery of the mobile device to excite and read the tag.
15. The NFC component of the composite tag can be scanned and software used to highlight in cloud based software the composite tags that require battery changeout.
16. The NFC component allows the recording in the cloud based (asset monitoring/tracking) software of tools that have been damaged and are no longer fit for use or require repair.
17. The Bluetooth component of the composite tag can have sensors built in to record: temperature, humidity, pressure, motion (accelerometer), etc. which can record the start and stop time of an asset in use allocated to a particular user for white finger monitoring and record the physical state/condition of an asset.

### BRIEF DESCRIPTION OF THE DRAWINGS

Embodiments of the invention will now be described in detail, by way of example, with reference to the accompanying drawings, in which:

FIG. 1 (PRIOR ART) is a high-level block diagram illustrating a known distributed BTLE sensor system aggregated over wireless networks;

FIG. 2 (PRIOR ART) is a more detailed block diagram illustrating a BTLE server of FIG. 1;

FIG. 3 (PRIOR ART) is a more detailed block diagram illustrating a user device (PDA) of FIG. 1;

FIG. 4 (PRIOR ART) is a more detailed block diagram illustrating a BTLE device of FIG. 1;

FIG. 5 (PRIOR ART) is a high-level flow chart illustrating a method of aggregating a distributed BILE sensor system over wireless networks;

FIG. 6 shows an external perspective view of the housing of a composite tag according to an embodiment of the invention;

FIG. 7 shows the internal hardware of the tag of FIG. 6, showing a first sight of a circuit board;

FIG. 8 shows the hardware of FIG. 7, from the opposite side of the circuit board;

FIG. 9 is a schematic block diagram of the internal hardware of the composite tag of FIGS. 6 to 8;

FIG. 10 schematically illustrates an asset tracking database, showing the association of users and tag IDs of tags tethered to the users;

FIG. 11 schematically shows the process for adding an asset to the asset tracking database of FIG. 10;

FIG. 12 schematically shows the process for setting up a tether between an asset and a user in the asset tracking database of FIG. 10;

FIG. 13 schematically shows the process for recording the transfer of an asset from a first user to a second user in the asset tracking database of FIG. 10;

FIG. 14 illustrates the process for providing graphical indications to the user of a wireless portable device for locating an asset;

FIGS. 15(a)-15(e) show examples of user interface views during the process of FIG. 14;

FIG. 16 shows the processes carried out at various devices for logging the periods of usage of assets to which a wireless portable device is tethered; and

FIG. 17 schematically illustrates a user interface view displayed during the process of FIG. 16.

### DETAILED DESCRIPTION

In the following, like numerals will be used to denote like elements. Unless indicated otherwise, any individual design features, components or steps mentioned herein may be used in combination with any other features, components or steps disclosed herein.

FIG. 1 is a high-level block diagram illustrating a distributed BTLE sensor system 100 aggregated over wireless networks. The system 100 comprises a BTLE server 110, an access point 120A a community user device 102 and an enterprise user device 104, coupled to a network 101 preferably over wired connections. A user device (sensor) 13 OA is wirelessly coupled to the access point 120A over a Wi-Fi connection, and is wirelessly coupled to a BTLE device (asset) 140A over a Bluetooth connection. Additional network components can also be part of the system 100, such as firewalls, virus scanners, routers, switches, application servers, databases, as well as additional controllers, access points, access switches, controllers, stations, and the like. The network components can be implemented as hardware, software, or a combination of both.

In an embodiment, there are multiple different sensors in the system 100A. The more sensors reporting sensor events from different locations, the larger the coverage area for asset tracking. The sensors belong to independent and unassociated users. Different sensors can be different devices, the same devices from different manufacturers, or identical devices. An asset can be picked up by different sensors at different locations, the same sensor at different locations, or different sensors at the same locations. In some cases, sensor events are essentially random events because there is no relationship between the sensor and the asset other than both being associated generally with the system 100A (e.g., community asset tracking). In other cases, sensor events are planned (e.g., heartbeat monitoring).

The BTLE server 110 receives and analyses sensor events from the user devices 120 coming into contact with BTLE devices 130. One embodiment can format sensor event data in a data portion of a frame including a unique identifier, a time/date stamp, a location, and any additional information for an implementation. Raw sensor event data is stored in a searchable format for later reference. Business rules can be applied to raw data to determine aggregate sensor data for the system 100 as a whole or just a particular user. Real-time alerts or notifications are sent out based on certain triggers, such as when an asset is found, an asset is in danger, a location has changed, a connection heartbeat is lost, a certain number of a set of assets have reached a predetermined condition, and the like.

The BTLE server 110 can be implemented in any of the computer devices discussed herein, a personal computer, a smart telephone, a server blade, a virtual storage network, or software as a service (SaaS), for example.

The access point 120A serves as a gateway to the network 101 for transmitting sensor events to the BTLE sensor 110. Typically, the user device 130A is associated with a BSSID assigned to the user access point 120A. Alternatively, a router, repeater or other network component can provide Wi-Fi access to the network 101.

The user device 130A is Bluetooth-enabled sensor that reads information from BILE devices 130 within radio range. For example, by enabling Bluetooth networking on a smart telephone, asset scanning occurs periodically as a user moves to different locations. Beacons are detected and include a unique identifier along with other data. In an embodiment, BTLE devices 140A considered assets within the system 100A are assigned unique identifiers having a recognizable prefix (e.g., first four characters are common for the system 100A). The user device 130A locally processes beacon data by adding time/data stamp and location information. In some cases, the user device 130A applies local rules to analyse data. One rule locally monitors heartbeats.

Another rule identifies an asset sought by the system 100 and, in response, pairs with the BTLE device 140A to deliver data or interrogate for data, as discussed further below. Pairing can be limited to certain transactions and a certain amount of time because some sensors only support one Bluetooth pairing at a time.

The user device 130A comprises a mobile or stationary computerized device. The user device 130A can be a smart telephone, a tablet, a phablet, a personal computer, a server, or any other computing device (e.g., see FIG. 8). An embodiment includes a Wi-Fi radio and one or more Bluetooth radios. A software program, mobile app can be downloaded to and executed on the user device 130A, or be integrated to an operating system.

The BTLE devices 130 advertise a presence over a Bluetooth channel to pass information to the BTLE sensor server 110. Some BTLE devices 130 have integrated Bluetooth capability while others are retrofitted. In one case, BTLE tag comprises a small sticker with a (low-powered) Bluetooth transmitter, a small circuit, and a thin profile battery is attached to an item. The low power consumption can allow a battery life of months or years, and when the battery runs out, the sticker is detached, thrown away, and replaced. A security module can encrypt broadcast data. Some tags on stationary assets can be programmed with a fixed location for transmission to sensors that do not have integrated location technology (e.g., no GPS). Asset types can be encoded in unique identifiers (e.g., certain prefixes reserved).

In one embodiment, assets operate in a dual mode to also perform sensor functionality. In more detail, an asset can collect sensor events from other nearby assets and report to a sensor. For example, an asset placed at an intersection can collect sensor events from BTLE enabled vehicles that drive by the intersection and then report data during its own interaction with a sensor.

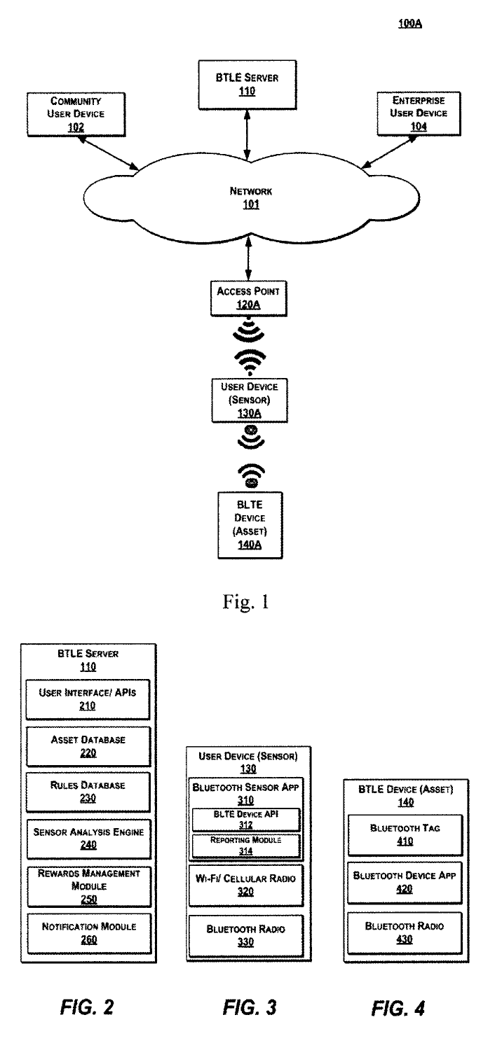

FIG. 2 is a more detailed block diagram illustrating a BTLE server 110 of FIG. 1. The BTLE server 110 comprises a user interface/APIs 210, an asset database 220, a rules database 230, a sensor analysis engine 240, a rewards management module 240, and a notification module 250, among other server software and hardware. Other examples can have different components. Further, the individual components can be locally stored and executed, be remotely executed by a software as a service, or be separate physical servers.

The user interface/APIs 210 provide an interaction portal for enterprise users and community users to log on to the BTLE server 110. Interactions can be provided through a search engine that can search general types of assets and related movement and use data. Also, user profiles can provide private interactions and secure data. Enterprise users can individually register or upload a group of assets and also configure rules for the assets. In another embodiment, enterprise users can search event data, set analysis parameters, and configure heart beat monitoring and asset tracking. Additionally, external processes can interact with the BLTE server 110 utilizing the user interface/APIs 210. APIs for sensors can be publicly available, or can be provided to partners on a more limited basis.

The asset database 220 can store registered assets associated with specific users and preferences. As sensor events occur, and as analysis results are determined by the sensor analysis engine 240. A relational database or table formats data into a searchable form. A rules database 230 stores rules applied against the registered assets. Some rules are general and are preconfigured for asset tracking, lost and found, or any of the specific case uses. Some rules are customized for a particular user, for a particular asset type, for a particular movement behaviour, and the like.

FIG. 3 is a more detailed block diagram illustrating a user device 120 (generically referring to the access points 120A-C) of FIG. 1, according to an embodiment. The user device 120 comprises a Bluetooth sensor app 310, a Wi-Fi/cellular radio 320, and a Bluetooth radio 330.

FIG. 4 is a more detailed block diagram illustrating a BTLE device 130 (generically referring to the BTLE devices 130A-D) of FIG. 1, according to an embodiment. The BTLE device 130 comprises a Bluetooth tag 410, 1 Bluetooth device app 420, and a Bluetooth radio 430.

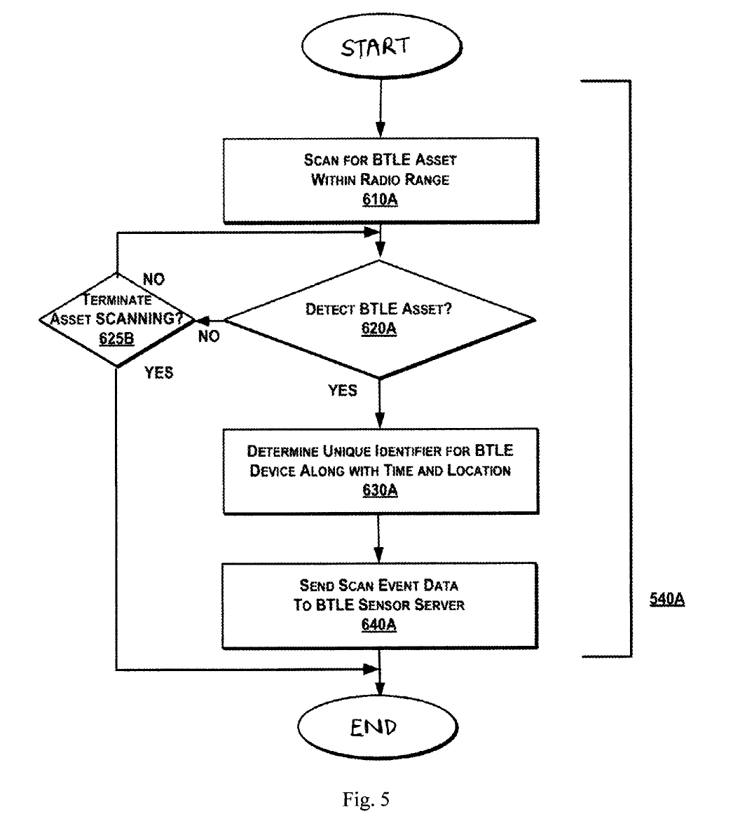

FIG. 5 is a high-level flow chart illustrating a method 500 of aggregating a distributed BILE sensor system over wireless networks, according to an embodiment. The order of steps and grouping of functions in each step are only examples of many possible variations.

A user profile is created (step 510). An asset list associated with the user profile is uploaded and rules are configured (step 520). An item is enabled as a BILE asset (step 530). To do so, a BTLE tag and/or software are set up at the BILE asset. Scan events for BTLE assets are reported by distributed BTLE sensors (step 540), as described in more detail below. Scan events are analysed using business rules by a BTLE server (step 550), also as described below in more detail. Notifications and/or reports are sent based on the analysis (step 560).

In implementing the present invention, techniques disclosed in US 2016/0105762 A1 may be used as appropriate, except as described otherwise hereinafter.

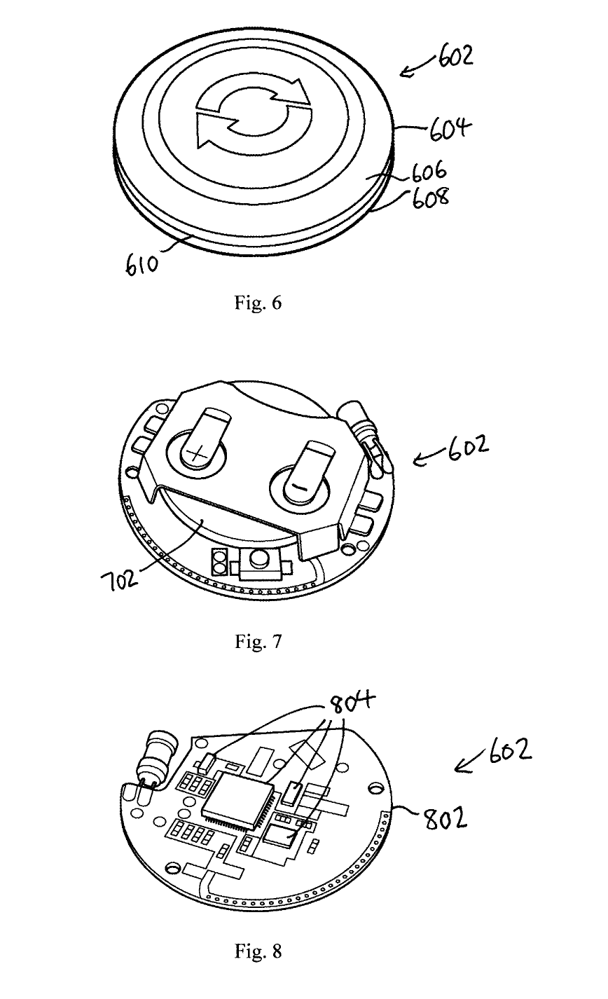

FIG. 6 shows an external perspective view of the housing of a composite tag according to an embodiment of the invention. The housing 604 may be made of any suitable plastics material and formed by moulding techniques that are well known in the art. The housing 604 may be moulded as a unitary housing, or may be formed by two housing halves 606, 608 which are joined by suitable plastics welding techniques at joint 610.

FIG. 7 shows the internal hardware of the tag of FIG. 6, showing a first sight of a circuit board. The composite tag 602 includes a battery 702 for powering a Bluetooth™ component, or for pairing a Bluetooth component and an NFC component, which will be described in further detail below.

FIG. 8 shows the hardware of FIG. 7, from the opposite side of the circuit board. On this side of the circuit board 802 are various electronic components 804 making up the composite tag 602, as will be described in more detail hereinafter.

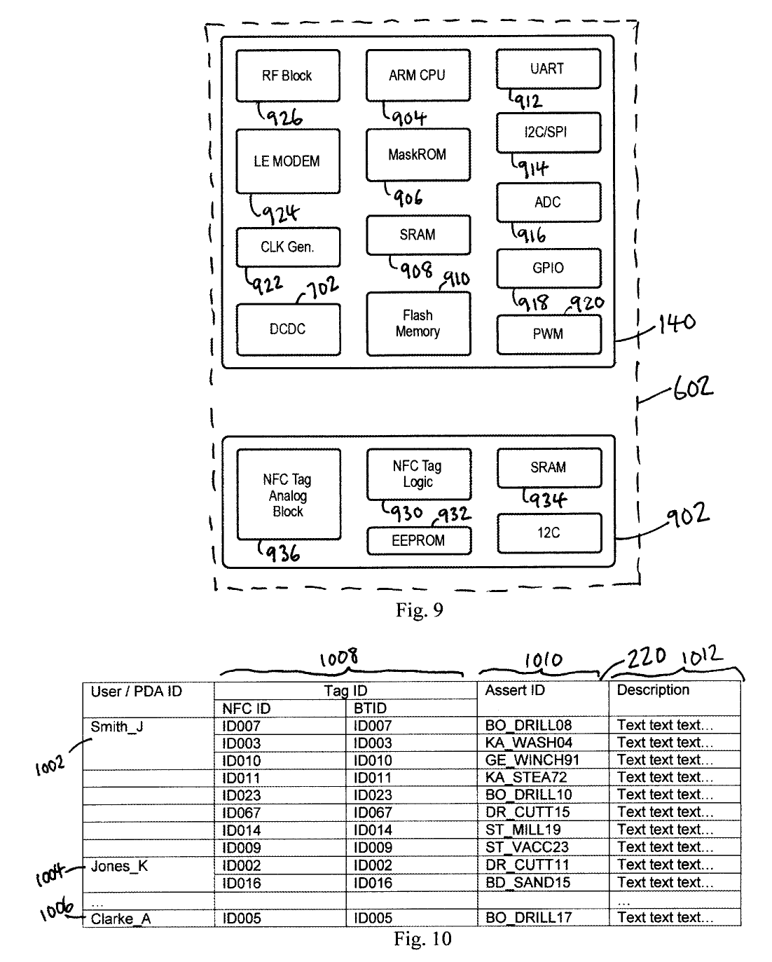

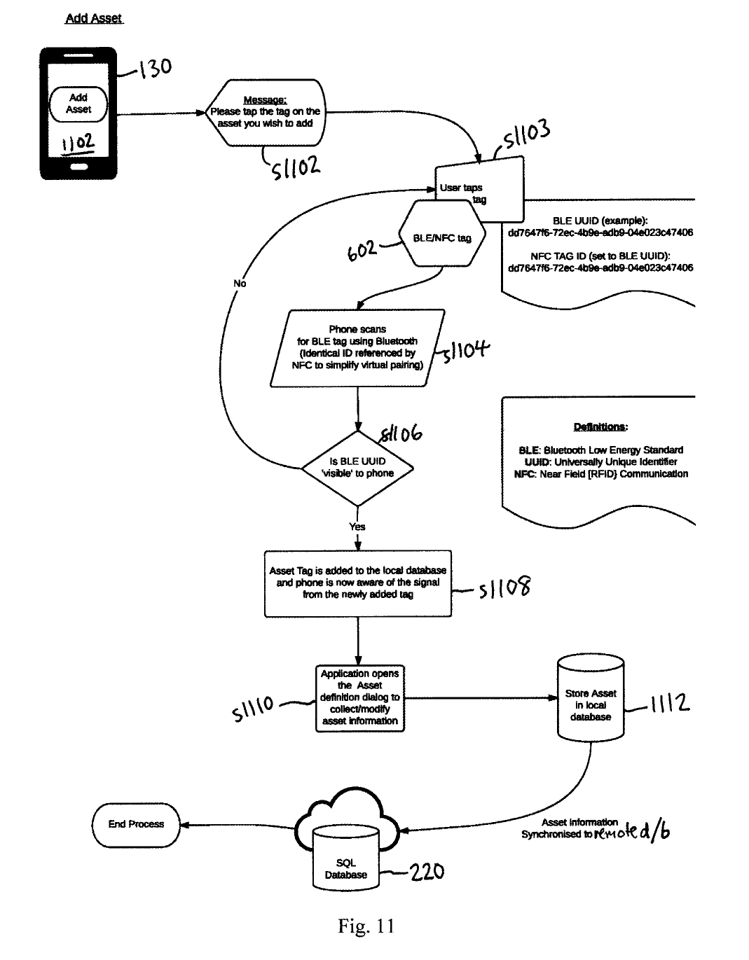

FIG. 9 is a schematic block diagram of the internal hardware of the composite tag of FIGS. 6 to 8. In accordance with an embodiment of the invention, the composite tag 602 comprises a Bluetooth component 140 and an NFC component 902. The Bluetooth component 140 and the NFC component 902 may be fabricated as separate components and combined onto the same package (circuit board), or may be fabricated as an integrated device (chip) (not shown).

Within Bluetooth component 140, CPU 904 is interoperable with memory devices 906, 908 and 910. Additional interfaces and/or components 912-920 are also coupled to and interoperable with CPU 904 in a conventional manner, as will be appreciated by persons skilled in the art. A clock signal is provided to the components by clock generator 922, and power is provided thereto by battery 702. Low energy modem 924 and RF block 926, operating under the control of CPU 904, form a Bluetooth wireless interface for the transmission of Bluetooth signals complying with the Bluetooth standard. In accordance with embodiments of the invention, this Bluetooth wireless interface is operable in broadcast mode only (i.e. it is incapable of receiving).

The NFC component 902 includes NFC tag logic 930 interoperable with memory devices 932 and 934. An NFC analogue block 936, in use under the control of NFC tag logic 930, provides an NFC wireless interface broadcasting, in use, NFC signals complying with the NFC standard.

In accordance with embodiments of the invention, both the Bluetooth component 140 and the NFC component 902 are encoded with an identifier (tag ID) unique to the tag 602, and the IDs for the Bluetooth component 140 and the NFC component 902 are the same.

The Bluetooth wireless interface of Bluetooth component 140 is operable to broadcast Bluetooth signals at intervals, with a periodicity T1. In embodiments, as well as including the tag ID, the Bluetooth signals include measurements detected by temperature, humidity, pressure and/or motion (accelerometer) sensors (not shown) which form part of the Bluetooth component 140 in embodiments of the invention.

The NFC wireless interface of NFC component 902, in use, may broadcast NFC wireless signals including the tag ID under battery power. In any event, NFC component 902 is operable as a passive component, and may, in use, be interrogated by an NFC reader (not shown), in response to which the NFC wireless interface broadcasts the NFC wireless signals including the tag ID.

FIG. 10 schematically illustrates an asset tracking/management database (also referred to herein as “asset database”) 220, showing the association of users and tag IDs of tags tethered to the users. It can be seen that associated with each user ID 1002, 1004, 1006 are one or more tag IDs generally designated as 1008. Uniquely associated with each tag ID 1008 is an asset ID 1010. There may also be provided in asset database 220 a description 1012 of the asset corresponding to the asset ID 1010. In the particular embodiment illustrated, a first user 1006 (Clarke_A) has one asset (BO_DRILL 17) associated with him, whereby a single tag ID 1008 (ID 005) is tethered to that user 1006. A second user 1004 has two tag IDs 1008 (ID 002 and ID 016) tethered to his wireless portable device (PDA) 130. However, the first listed user 1002 (Smith_J) has eight tag IDs 1008 tethered to his PDA. That is, in the latter case, a large number of Bluetooth IDs (BTID) are virtually associated with the user (PDA) 1002.

FIG. 11 schematically shows the process for adding an asset to the asset tracking database of FIG. 10. Initially, a message appears in the user interface 1102 inviting the user to tap with his PDA 130 the tag (composite tag 902) on the asset he wishes to add. At step s1104, the PDA (e.g. phone) scans for signals from Bluetooth component 140 (not shown) using a Bluetooth receiver (not shown) within PDA 130. A check is then made (s1106) as to whether the BLE UUID (BTID) is visible to the PDA. If it is not visible, the user can tap again at the composite tag 902 at step s1103.

If, however, the BLE UUID is visible to the PDA, the asset tag (tag ID) is added to a local database within the PDA or more preferably within the network of the site where the PDA is being used (step s1108). Next, at step s1110, the running application on the PDA opens an asset definition dialog to collect/modify asset information, as a consequence of which updated asset database data is transferred to local database 1112. In turn, the updated asset data may be synchronized to a (cloud based) asset database 220 at a remote server.

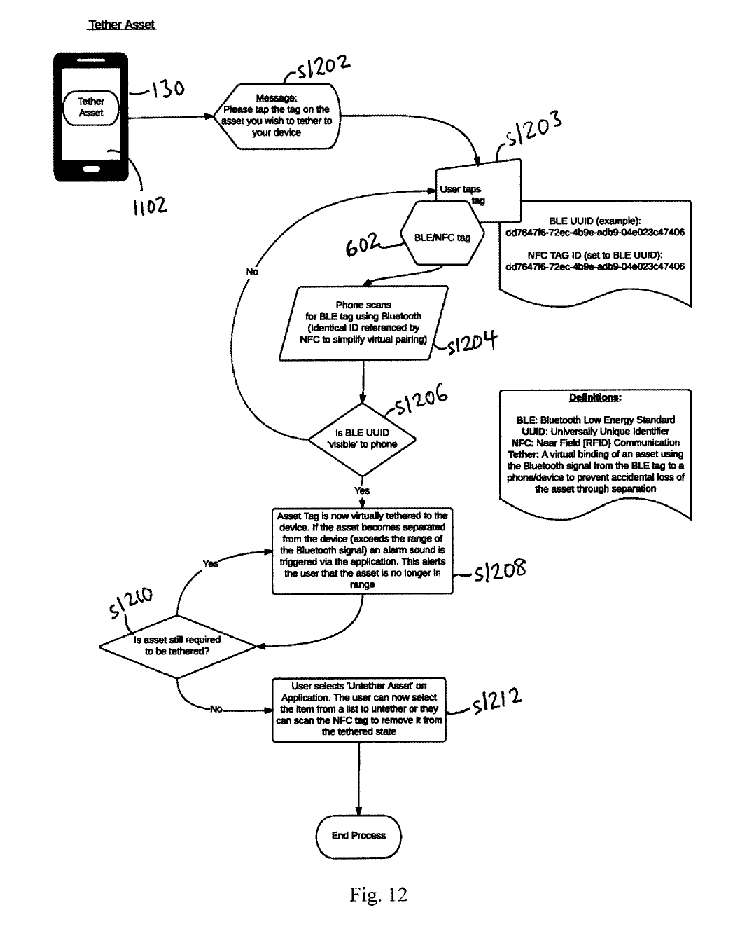

FIG. 12 schematically shows the process for setting up a tether between an asset and a user in the asset tracking database of FIG. 10. As a first step s1202, there is displayed in the user interface 1102 of PDA 130 a message inviting the user to tap his PDA 130 on the tag of the asset he wishes to tether to his PDA. The PDA is “tapped” on the composite tag 902 at step s1203. The PDA then scans (step s1204) for signals from Bluetooth component 140 using a Bluetooth receiver in the PDA. A check is made (step s1206) as to whether the BLE UUID (BTID; FIG. 10) is visible to the PDA. If not, processing returns to step s1203.

If, on the other hand, the BLE UUID is visible to the PDA, a database on the PDA and/or an asset database (220) on a remote server (not shown) is updated whereby the asset tag (tag ID) is “virtually” tethered to the PDA (user/PDA ID) (step s1208). Next, a check is made (step s1210) as to whether the asset is still required to be tethered. If so, processing returns to step s1208. If, however, the asset is not required still to be tethered to the PDA, as indicated to the PDA via user selection of “untether asset” in the user interface 1102 of the running application, the asset may then be untethered either by the user selecting the asset from a list or by scanning NFC tag (NFC component 902; FIG. 9) to remove the asset from its tethered state (step s1212).

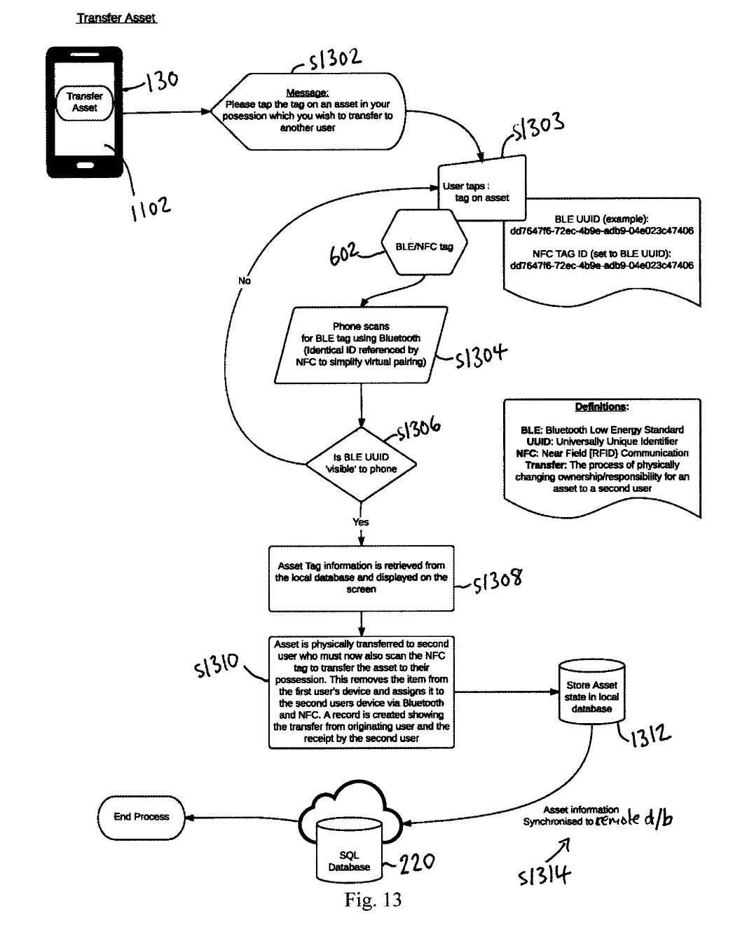

FIG. 13 schematically shows the process for recording the transfer of an asset from a first user to a second user in the asset tracking database of FIG. 10. The process commences (step s1302) with the display on the user interface 1102 of PDA 130 of a message inviting the user to tap his PDA 130 on the tag of an asset within his possession which he wishes to transfer to another user. At step s1303, the user taps his PDA on the tag of the asset. At step s1304, the PDA scans for signals from the Bluetooth component 140 (not shown) of composite tag 602 using a Bluetooth receiver on the PDA 130. A check is then made (step s1306) as to whether the BLE UUID (BTID) is visible to the PDA. If now, processing returns to step s1303.

If, on the other hand, the BLE UUID is visible to the PDA, asset tag information is retrieved from the local database (FIG. 10) and displayed in the user interface 1102 of PDA 130 (step s1308). Once the asset is physically transferred to the second user, the latter scans the NFC component 902 of composite tag 602, and thereby receives the tag ID via NFC wireless interface (step s1310). This step has the effect of removing the asset from the first user's PDA (tethering) and assigning it to the second user's PDA via the Bluetooth and NFC wireless user interfaces. A record is created showing the transfer from the first user and the receipt by the second user and this record is stored in local database 1312. The updated asset state (tethering) may further be synchronised (step s1314) with an asset database 220 existing on a remote (e.g. cloud based) server.

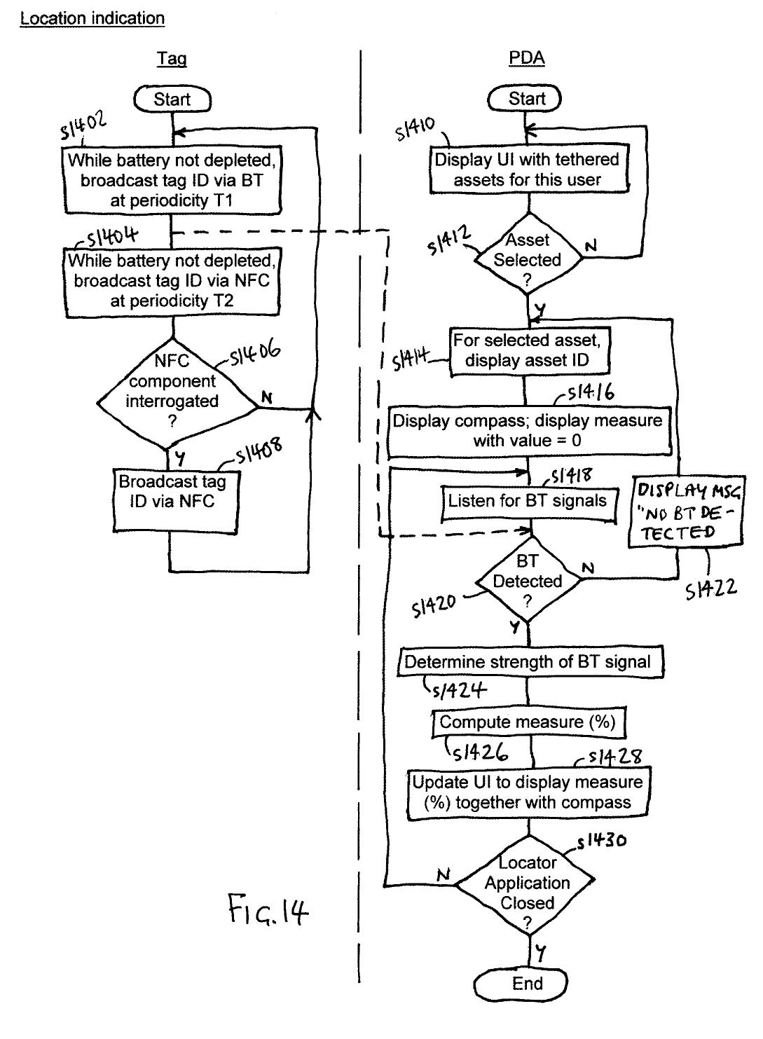

FIG. 14 illustrates the process for providing graphical indications to the user of a wireless portable device for locating an asset. At the composite tag on the asset (not shown), the tag ID (BTID; FIG. 10) is broadcast via the wireless Bluetooth interface with a periodicity T1, while the battery powering the Bluetooth component 140 is not depleted (step s1402). The NFC wireless interface of NFC component 902 may also broadcast the tag ID (NFC ID; FIG. 10) with a periodicity T2 under power of the battery of the tag 602 (step s1404). Otherwise, while the NFC is operable in passive mode, if it is determined (step s1406) that the NFC component 902 has been interrogated by an NFC reader (not shown), then the tag ID (NFC ID; FIG. 10) is broadcast by NFC component 902. Processing then returns to step s1408.

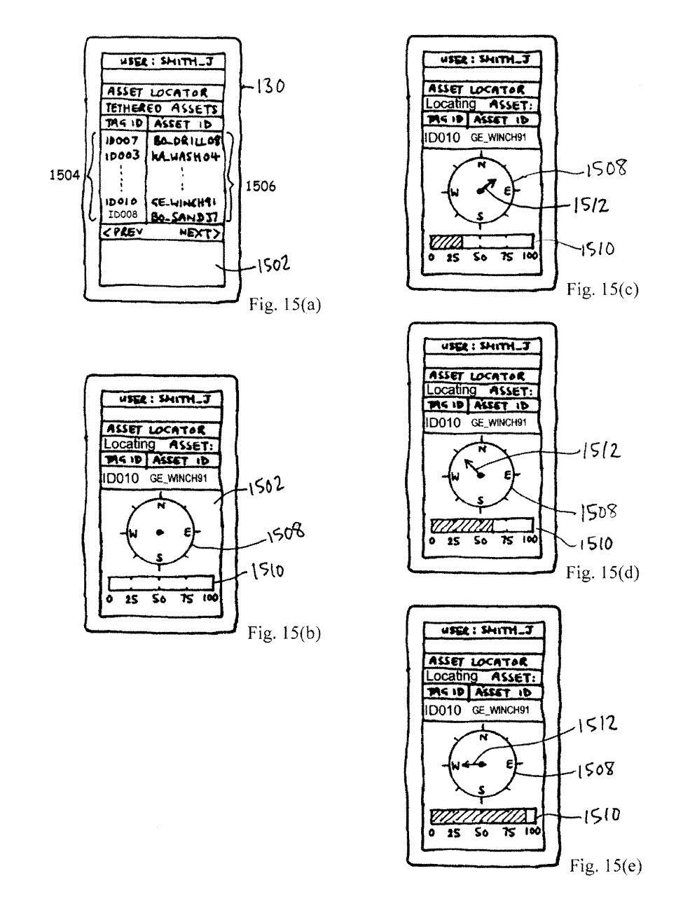

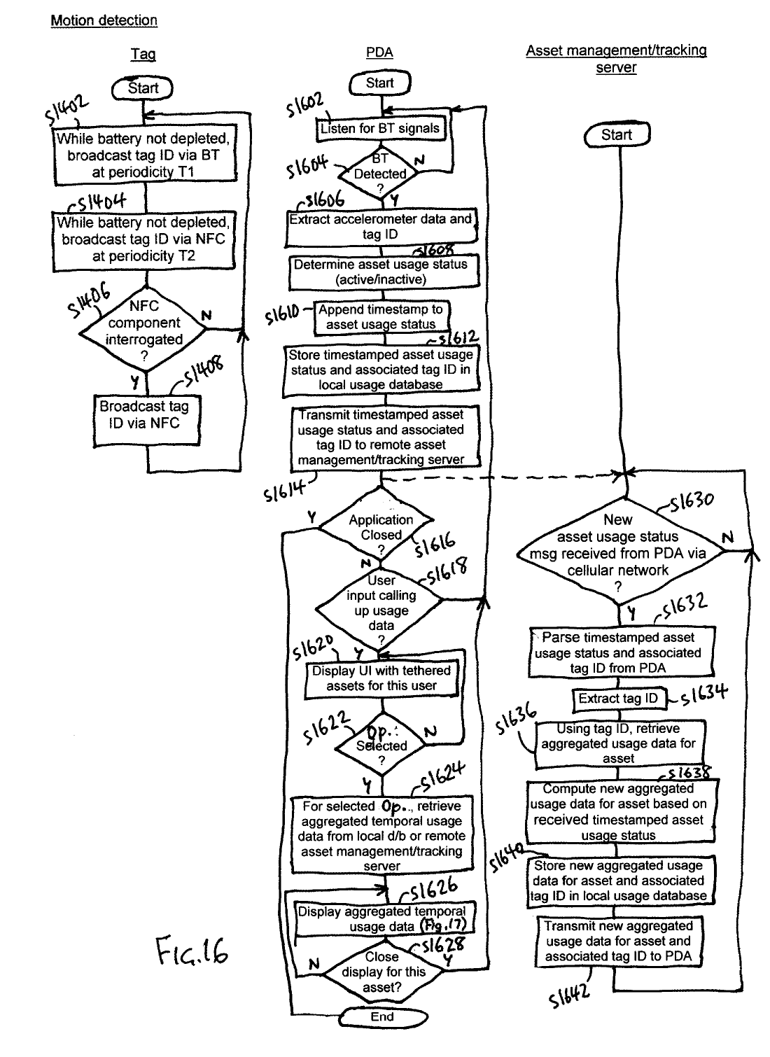

The processing at the PDA 130 commences (step s1410) with the display in the user interface of the tethered assets for the user of this PDA 130. (FIGS. 15(a)-15(e) show examples of user interface views during the process of FIG. 14.) A check is made as to whether a user input has been received selecting an asset (step s1412). If not, processing returns to step s1410. Also displayed (step s1416) is a compass 1508 and a measure or meter 1510 within user interface 1502. Next (step s1418), the PDA 130 listens for Bluetooth signals. A check is made (step s1420) as to whether Bluetooth signals are detected by PDA 130. If not, a message such as “no Bluetooth detected” is displayed (s1422) and processing returns to step s1414.

If, on the other hand, Bluetooth signals have been detected, the strength of the Bluetooth signal is determined at step s1424. A measure is then computed, e.g. as a percentage, based on the determined strength of the Bluetooth signal (step s1426). Next, the user interface 1502 (FIG. 15c) is updated to display the computed measure as a percentage together with a compass with an arrow 1512 indicating the current orientation (step s1428). Then, until it is detected (step s1430) that the locator application has been closed by the user, steps s1418 to s1428 are repeated as the user changes his orientation in order to detect the location of the asset. This is illustrated in FIGS. 15c-15e: from initially an approximately NE orientation (FIG. 15c) which produces a relatively low measure 1510 (c. 30%), as the user rotates to an approximately NW orientation (FIG. 15d) producing an increased measure 1510 (c. 65%), the user eventually reaches a substantially westerly orientation (FIG. 15e) whereupon a measure 1510 approaching a maximum of 100% is displayed, thereby indicating that the asset is to the west.

FIG. 16 shows the processes carried out at various devices for logging the periods of usage of assets to which a wireless portable device is tethered. In FIG. 16, the process at the tag is the same as in FIG. 14, left hand column, and therefore the description thereof will not be repeated, for brevity.

At the PDA 130, the process commences by listening (step s1602) for Bluetooth signals. If it is determined (step s1604) that Bluetooth signals have not been detected, processing returns to step s1602.

On the other hand, if Bluetooth signals from Bluetooth component 140 (FIG. 9) are detected, the accelerometer data and tag ID within the broadcast Bluetooth signals are extracted (step s1606). Then, from the accelerometer data, the usage status (active/inactive) of the asset at the time of arrival of the Bluetooth signals is determined (step s1608) and a time stamp applied to that asset usage status (step s1610). Optionally, the time stamp asset usage status and associated tag ID are stored in a local usage database on the PDA 130 (step s1612). In this embodiment, the time stamp asset usage status and associated tag ID are transmitted to a remote asset management/tracking server 220 (step s1614).

Referring to the right hand column in FIG. 16, at the asset management/tracking server 220 a check is made at regular intervals (step s1630) as to whether a new asset usage status message has been received from PDA 130 (e.g. via the cellular network). If not, processing returns to step s1630.

If, on the other hand, a new asset usage status message has been received, the message is parsed and the time stamp and other data extracted (step s1632). The tag ID within the message is also extracted (step s1634). Next, using the tag ID, aggregated usage data for the asset is retrieved from the asset database (step s1636). Then, new aggregated usage data for the asset is computed based on the received time stamped asset usage status (step s1638). Once computed, the new aggregated usage data for the asset, associated with the tag ID, is stored in the asset database (usage database), as indicated at step s1640. Then, the new aggregated usage data for asset and associated tag ID is transmitted (step s1642) to the PDA 130, and processing returns to step s1630.

Referring again to the central column in FIG. 16, if the motion/usage detection application has not been closed as determined at step s1616, a check is made (step s1618) as to whether a user input has been received calling up usage data. If not, processing returns to step s1602.

On the other hand, if the user has made an input to call up usage data, a user interface is displayed (step s1620) including the tethered assets for the user (see FIG. 15a). The user interface may provide an option (not shown) enabling the tethered assets to be filtered to indicate only those having been used by a particular operative or worker. A check is made (step 1622) as to whether an operative/worker ID has been selected. If not, processing returns to step s1620.

If, on the other hand, an operative/worker ID has been selected at step s1622, then, for selected operative/worker, the aggregated temporal usage data is retrieved from local database or the remote asset management/tracking server (step s1624). The retrieved aggregated temporal usage data (step s1626).

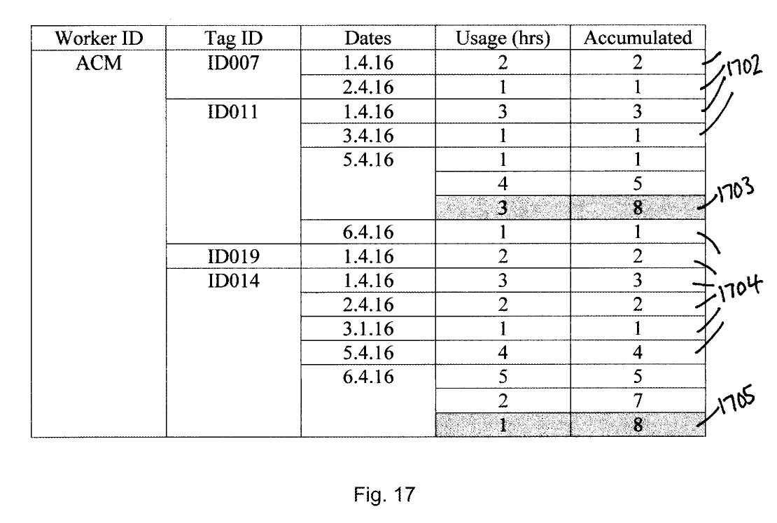

FIG. 17 schematically illustrates a user interface view 1700 displayed during the process of FIG. 16, i.e. at step s1626: this displays the aggregated temporal usage data. As can be seen in FIG. 1, there may be displayed, for the given operative/worker (“ACM”), the tag IDs for each of the assets to which the PDA 130 (user) is tethered. Also, for each tad ID, there may be displayed the or each date on which the asset corresponding to the tag ID was used. For each of the latter, there may be displayed the time (e.g. number of hours) which the asset corresponding to the tag ID was used. In any event, there is preferably displayed the accumulated/aggregated time for each day, i.e. at 1702, 1704, 1706 and 1708. Supposing there is a safety requirement that the aggregated time per user on any given day must not exceed 7 hours. It can be seen that aggregated times 1702 and 1704 are in compliance. However, where the aggregated times (1703 and 1705) exceed a predetermined maximum (e.g. 7 hrs), those aggregated times are displayed in the user interface 1700 in a highlighted manner (e.g. in red or with coloured highlighting background).

While embodiments have been described by reference to embodiments of stock monitoring systems having various components in their respective implementations, it will be appreciated that other embodiments make use of other combinations and permutations of these and other components.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other. For example, in the context of airflow, where an outlet of A is coupled to an inlet of B it may be that one or more additional devices are provided between the outlet of A and the inlet of B.

Thus, while there has been described what are believed to be the preferred embodiments of the invention, those skilled in the art will recognize that other and further modifications may be made thereto without departing from the spirit and scope of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. An asset tag adapted to be mounted to an asset, the asset tag comprising:
a first component encoded with a first ID unique to the asset tag, the first component having a first wireless interface and being adapted to transmit first broadcast signals via said first wireless interface over a first range, the first broadcast signals including the first ID; and
a second component encoded with a second ID unique to the asset tag, the second component having a second wireless interface and being adapted to transmit second broadcast signals via said second wireless interface over a second range, the second broadcast signals including the second ID;
wherein the first range and the second range are different; and
wherein the first ID and the second ID are identical.

2. The asset tag of claim 1, wherein the first wireless interface is a transmit-only wireless interface.

3. The asset tag of claim 1, wherein the first wireless interface is adapted to transmit the first broadcast signals with a first periodicity T1.

4. The asset tag of claim 1, wherein the first wireless interface is a battery-powered wireless interface.

5. The asset tag of claim 1, wherein the first wireless interface is a Bluetooth interface.

6. The asset tag of claim 1, wherein the second wireless interface is a wireless transceiver.

7. The asset tag of claim 1, wherein the second wireless interface is adapted to transmit the second broadcast signals with a second periodicity T2.

8. The asset tag of claim 1, wherein the second wireless interface is a passive wireless interface.

9. The asset tag of claim 1, wherein the second wireless interface is adapted to transmit, upon interrogation by a corresponding reader device, a second broadcast signal.

10. The asset tag of claim 1, wherein the second wireless interface is a NFC interface.

11. A method of tethering an assert to a portable asset tracking device, the portable asset tracking device having a unique device ID and being coupled via a third wireless interface to a remote asset tracking server, the method comprising:
providing at least one asset, the or each asset having mounted thereto an asset tag according to claim 1;
upon being brought into proximity or tapped onto the asset tag of the or each asset,
receiving the respective second broadcast signal;
decoding the second broadcast signal to obtain the second ID;
retrieving the device ID; and
updating an asset tracking database on the portable asset tracking device and/or at the remote asset tracking server to include an association between the device ID and the second ID.

12. A method of transferring an assert that is tethered to a first portable asset tracking device to a second portable asset tracking device, each portable asset tracking device having a unique device ID and being coupled via a third wireless interface to a remote asset tracking server, the method comprising:
providing an asset, the asset having mounted thereto an asset tag according to claim 1;
upon the first portable asset tracking device being brought into proximity or tapped onto the asset tag of the asset,
receiving the first broadcast signal;
decoding the first broadcast signal to obtain the first ID;
using the first ID, retrieving the asset data corresponding to the tag from an asset database;
receiving a first user input at the first portable asset tracking device indicating that the asset has been transferred; and
upon the second portable asset tracking device being brought into proximity or tapped onto the asset tag of the asset,
receiving the second broadcast signal; and
decoding the second broadcast signal to obtain the second ID;
updating an asset tracking database on the second portable asset tracking device and/or at the remote asset tracking server to include an association between the device ID of the second portable asset tracking device and the second ID.

13. The method of claim 12, wherein method comprises, after said step of retrieving the asset data corresponding to the tag from an asset database, displaying the asset data in a user interface of the first portable asset tracking device.

14. A method of tracking the location of an asset at a site using a wireless portable device, the wireless portable device including a receiver and an orientation-sensing device for providing an orientation signal, the asset having mounted thereto a tag according to claim 1, the method comprising:
receiving a first user input at the wireless portable device, the first user input selecting the asset;
receiving via the receiver one or more of said first broadcast signals;
determining the signal strength of said one or more of said first broadcast signals;
deriving a measure based on the signal strength;
determining the current orientation of the wireless portable device based on said orientation signal; and
graphically displaying (i) an orientation element indicating the current orientation and (ii) the measure.

15. The method of claim 14, wherein the orientation element comprises a compass.

16. The method of claim 14, wherein the measure comprises a bar of length corresponding to the determined signal strength.

17. A method of measuring usage of an asset, the asset comprising a manually-operable tool having mounted thereto a tag according to claim 1, the tag including an accelerometer for generating, in use, accelerometer data indicative of whether the asset is active or inactive, the method being carried out on a wireless portable device, the method comprising:
receiving one or more first broadcast signals, the first broadcast signals including the first ID of the tag and the accelerometer data;
determining, from the accelerometer data, whether an asset usage status is active inactive,
storing or causing to be stored the asset usage status and associated first ID and a timestamp of the current time in a usage database;
in response to a first user input at the wireless portable device, the first user input selecting the asset,
retrieving aggregated temporal usage data for the selected asset, the aggregated temporal usage data being based at least in part on the asset usage status; and
graphically displaying the aggregated temporal usage data.

18. The method of claim 17, wherein the graphically displayed aggregated temporal usage data comprises, for a given operative, one or more tag IDs and, associated with each tag ID, at least an aggregated usage time for each day of usage.

19. The method of claim 17, wherein storing or causing to be stored the asset usage status and associated first ID and a timestamp of the current time in a usage database comprises (i) storing the asset usage status in a local database on the wireless portable device and (ii) causing the asset usage status to be stored comprises causing the asset usage status to be stored on a usage database on a remote assert server.

20. The method of claim 17, wherein retrieving the aggregated temporal usage data for the selected asset comprises retrieving the aggregated temporal usage data from (i) a local database on the wireless portable device or (ii) a usage database on a remote assert server.
